(19) United States
(12) Patent Application Publication
(10) Pub. No.: US 2004/0196460 A1
(43) Pub. Date: Oct. 7, 2004

(54) Scatterometric measuring arrangement and measuring method

(76) Inventors: Hans-Jurgen Dobschal, Kleinromstedt (DE); Gunter Machke, Jena (DE); Jorg Bischoff, Ilmenau (DE)

Correspondence Address: Douglas J Christensen, Patterson Thuente Skaar & Christensen, 4800 IDS Center, 80 South Eighth Street, Minneapolis, MN, 55402, US

(21) Appl. No.: 10/472,253

(22) PCT Filed: Sep. 18, 2002
(86) PCT No.: PCT/EP02/10476

(30) Foreign Application Priority Data
Sep. 24, 2001 (DE) 10146945.4

(51) Int. Cl. G01J 4/00; G01J 3/28

(52) U.S. Cl. 356/369; 356/328

(57) ABSTRACT

In a measurement arrangement comprising an optical device, into which a diverging beam coming from a specimen is coupled for measurement, and further comprising a detector, which is arranged following said optical device and comprises a multiplicity of detector pixels arranged in one plane and evaluable independently of each other, wherein the optical device spectrally disperses the diverging beam in a first direction transversely of the propagation direction of the beam and directs it to the detector, the optical device also parallels the beam, before it impinges on the detector, in a second direction transversely of the propagation direction (C) such that rays of the beam impinging on the detector, which are adjacent to each other in the second direction, extend parallel to each other.

The invention relates to a measurement arrangement comprising an optical device, into which a diverging beam coming from a specimen is coupled for measurement, and further comprising a detector, which is arranged following said optical device and comprises a multiplicity of detector pixels arranged in one plane and evaluable independently of each other, wherein the optical device spectrally disperses the diverging beam in a first direction transversely of the propagation direction of the beam and directs it onto the detector. Further, the invention relates to a method of measurement comprising the steps of: directing a beam onto a specimen to be examined such that a diverging beam comes from the specimen, effecting spectral dispersion of the diverging beam in a first direction transversely of the propagation direction of the diverging beam, and directing the spectrally dispersed beam onto a detector comprising a multiplicity of detector pixels arranged in one plane and evaluable independently of each other.

Such a measurement arrangement is used, for example, in optical scatterometry, with both photometry (the measurement of the intensity of radiation coming from a specimen as a function, for example, of the angle of reflection and/or the wavelength) and ellipsometry (the measurement of the polarization condition of radiation coming from a specimen as a function of, for example, the angle of reflection and/or the wavelength) being methods of optical scatterometry. The measured values obtained by these methods, also referred to as the optical signature of the specimen, may then be used to draw conclusions with regard to the examined specimen by means of suitable methods.

DE 198 42 364 C1 discloses a measurement arrangement and a method of measurement of the aforementioned type used in ellipsometry, wherein the specimen to be examined is imaged into the detector plane by means of the optical device in order to effect a space-resolved measurement.

It is an object of the invention to improve a measurement arrangement of the aforementioned type and a method of measurement of the aforementioned type such that a spectral measurement and an angle-resolved scatterometric measurement may be quickly effected on a specimen.

The object is achieved in a measurement arrangement of the aforementioned type in that the optical device also parallels the beam in a second direction transversely of the propagation direction, before the beam impinges on the detector, so that rays of the beam impinging on the detector, which are adjacent to each other in the second direction, extend parallel to each other. This allows the intensity of the beam to be detected simultaneously as a function of the angle of reflection and of the wavelength, thus advantageously shortening the measuring time considerably.

Therefore, a particular advantage of the measurement arrangement according to the invention consists in that angle-resolved and spectrally resolved information is obtainable by one single measurement, without having to mechanically move any parts during measurement. This allows the measurement to be effected extremely precisely and very quickly, which is a great advantage, in particular with a view to process control, for example, in semiconductor manufacture.

The first and second directions preferably extend perpendicular to the propagation direction, said first and second directions particularly preferably also enclosing an angle of 90° between each other. Advantageously, this allows the evaluation of the measured data to be facilitated, because there is only a spectral dependence in the first direction, while there is only an angular dependence in the second direction.

Particularly preferably, the optical device parallels the beam completely (and, thus, also in the first direction). This allows spectral dispersion, which is carried out, in this case, particularly after paralleling, to be effected with high precision, so that the precision of measurement of the measurement arrangement is extraordinarily high.

A particularly preferred embodiment of the measurement arrangement according to the invention consists in that the optical device effects said spectral dispersion such that, in the first direction, focussing occurs in the plane of the detector pixels. Thus, the individual spectral components are focussed on the detector next to each other (or adjacent to each other in the first direction), thus achieving a very high resolution for the measurement as a function of the wavelength.

Particularly preferably, a cylindrical mirror is provided for focussing in the measurement arrangement according to the invention. Thus, the desired focussing may be achieved in a simple manner and without causing chromatic aberration. Further, using the cylindrical mirror, the optical path may be folded such that the measurement arrangement may be realized in a compact manner.

In particular, the optical device in the measurement arrangement according to the invention may include a dispersive element, such as a groove grating, for spectral dispersion. Using this dispersive element, the desired spectral dispersion can be securely effected only in the first direction.

The dispersive element is preferably embodied as a reflective element, such as a reflective groove grating. This allows the optical path to be folded, which makes the measurement arrangement compact. A combination of the cylindrical mirror for focussing and of the reflective, dispersive element is particularly advantageous, because folding the optical path twice leads to a very small measurement arrangement.

Further, an advantageous embodiment of the measurement arrangement according to the invention consists in that the optical device for paralleling comprises one, two, or more mirrors, in particular one, two, or more spherical mirrors. This allows the paralleling to be effected without causing chromatic aberrations which may appear when using refractive elements for paralleling. This leads to an improvement in the precision of measurement.

Further, it is also possible to provide the dispersive element, e.g. a grating, directly on the mirror surface of the paralleling mirror for spectral dispersion, so that the desired functions of the optical device can be realized by one single optical element.

If several mirrors are provided for paralleling, the dispersive element may be formed on one or more of the mirror surfaces of the mirrors, thus reducing the space requirement of the measurement arrangement.

In an advantageous embodiment of the measurement arrangement according to the invention, the optical device comprises a first optical module for paralleling the coupled-in beam and a second optical module, arranged following the first optical module, for spectral dispersion. Thus, it is possible to effect the different optical tasks (namely, paralleling and spectral dispersion) by means of separate optical modules which may be optimized exactly for their tasks, so that the measurement arrangement is suitable, in particular, for high-precision measurements.

It is particularly advantageous to effect paralleling prior to spectral dispersion, since paralleling is then easily realizable without causing undesired chromatic aberrations (e.g. by exclusive use of mirror elements for paralleling).

The detector pixels are preferably arranged in lines and columns, and spectral dispersion is effected in the column direction, whereas paralleling is carried out in the line direction. This results in a particularly easy evaluation of the detector pixels, because each detector pixel is attributed to a known wavelength and to a known angle of reflection. Of course, the spectral dispersion may also be effected in the line direction. In this case, the paralleling is then carried out in the column direction.

Further, in the measurement arrangement according to the invention, a micropolarization filter may be arranged preceding the detector, said micropolarization filter comprising a multitude of groups of pixels, each of which comprise at least two (preferably three) analyzer pixels for elliposmetry, having differently oriented main axes, and a transparent pixel for photometry. Thus, in particular, exactly one pixel of said groups of pixels is associated with each detector pixel. In this case, an ellipsometric measurement may be simultaneously effected in addition to the photometric measurement, said ellipsometric measurement also allowing angle-resolved and spectrally resolved information to be obtained by one single measurement operation. Thus, a multitude of different measured values can be detected by one single measurement operation, enabling a very precise and quick measurement.

Further, the measurement arrangement according to the invention may be provided with an illumination arm which generates a (preferably converging) beam for illumination of the specimen to be examined and directs said beam thereon such that a diverging beam comes from the specimen, which beam is then coupled into the optical device for examination. This provides a very compact measurement arrangement using which the specimen can be directly illuminated in a suitable manner.

Depending on the specimen to be examined, the illumination arm may be arranged relative to the optical device such that light reflected or transmitted by the specimen is coupled into the optical device as a diverging beam. This allows to always select the arrangement which is most suitable for the respective specimen. It is also possible to arrange the illumination arm so as to couple only that radiation from the specimen into the optical device which is of (a) predetermined order(s) of diffraction, if the latter are present. Alternatively, the optical device may also be arranged such that only the desired radiation is coupled in.

If the grating vector of the specimen portion to be examined (the grating vector characterizes the periodicity of the grid) lies in the plane of incidence (which is determined by the axis of the illumination arm and the axis of the measuring arm, which comprises the optical device and the detector), possibly present orders of diffraction will also be located in the plane of incidence. However, if the grating vector is not located in the plane of incidence, what is known as conical diffraction will occur, wherein all maxima of diffraction, except the zeroth order of diffraction (direct reflection), are located on an arc perpendicular to the plane of indicence. Accordingly, suitable positioning of the specimen (e.g. by rotation) ensures, in a simple manner, that only the direct reflection is coupled into the optical device and, thus, detected. Of course, the entire measurement arrangement may also be rotated about the normal of the specimen in order to produce said conical diffraction.

The object is achieved by the method of measurement according to the invention in that, in addition to the method of measurement of the aforementioned type, the diverging beam, before impinging on the detector, is also paralleled in a second direction transversely of the propagation direction such that the rays of the beam impinging on the detector, which are adjacent to each other in the second direction, extend parallel to each other. This allows an angle-resolved and a spectrally resolved photometric measurement to be carried out in one single measuring operation, without having to mechanically move any parts. This increases both the precision of measurement and the speed of measurement.

A specific embodiment of the method of measurement according to the invention consists in that only some of the detector pixels of the detector are evaluated, depending on the specimen to be examined. This allows the measurement to be accelerated, because those detector pixels whose information is less meaningful are not considered, so that an undesired slowdown of the method of measurement can be prevented. As a result, the method of measurement according to the invention becomes quicker and, at the same time, also exhibits very high precision. This also enables the fast and optimal measurement of different types of specimens.

Further, the method of measurement according to the invention allows a (preferably converging) beam having a defined polarization condition to be directed onto the specimen, in which case the light impinging on some of the detector pixels is then guided through analyzers, while the light impinging on the other detector pixels is not guided through said analyzers. This enables a combined ellipsometric and photometric measurement, wherein both measurements, again, may be effected in an angle-resolved and spectrally resolved manner in one single measuring operation. Thus, a very large number of measured values are detected very quickly, allowing highly precise conclusions as to the desired parameters of the specimen to be examined.

In the method according to the invention, the beam is focussed on the specimen, and then the beam reflected or transmitted by the specimen is measured. The size of the specimen spot to be examined may then be adjusted by said focussing or also by possible defocussing of the incident beam.

The invention will be explained in more detail below, by way of example, with reference to the drawings, wherein:

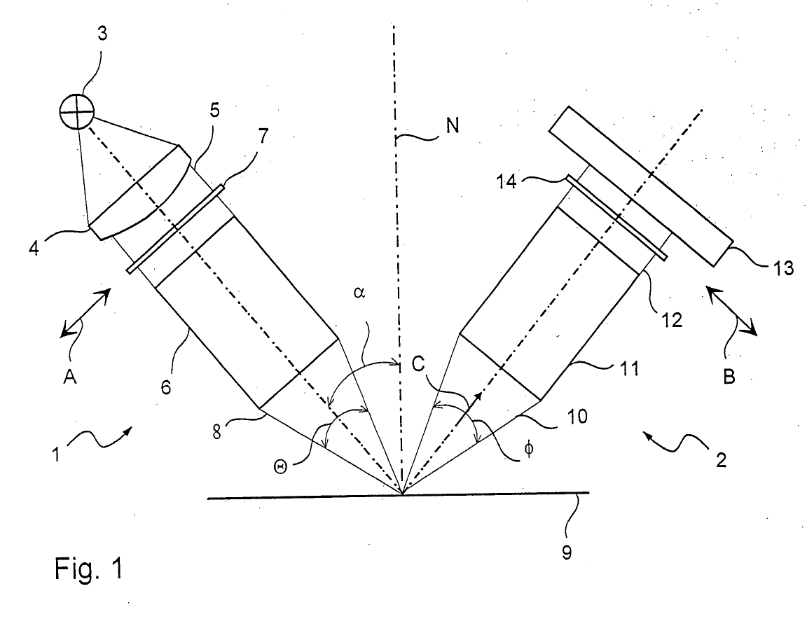

FIG. 1 shows a schematic construction of a measurement arrangement according to the invention;

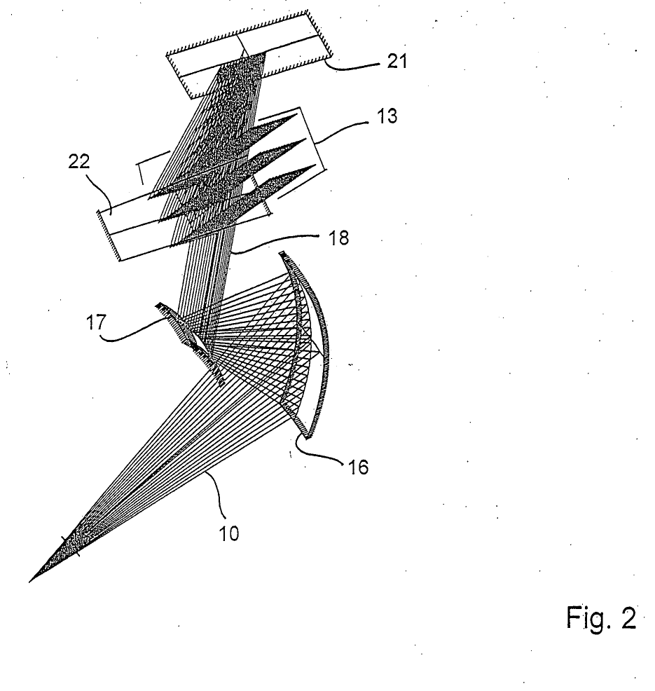

FIG. 2 shows a perspective view of the construction of the measuring arm of the measurement arrangement shown in FIG. 1;

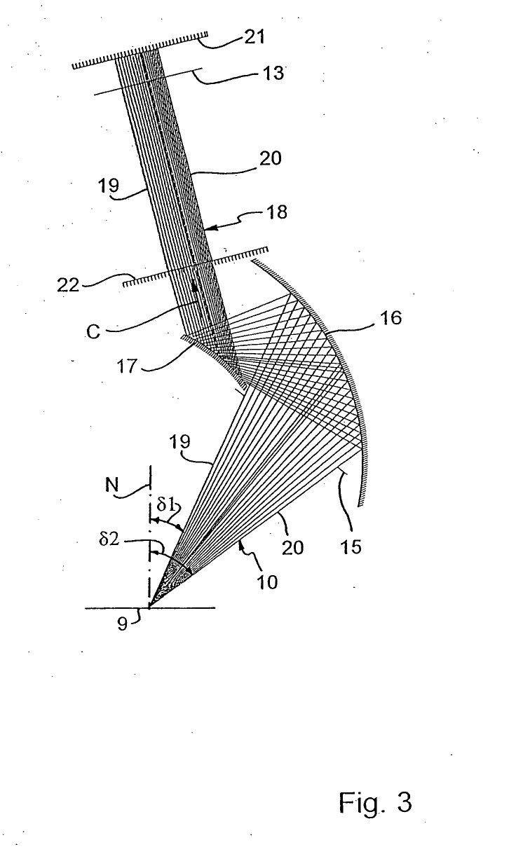

FIG. 3 shows a lateral view of the measuring arm of FIG. 2;

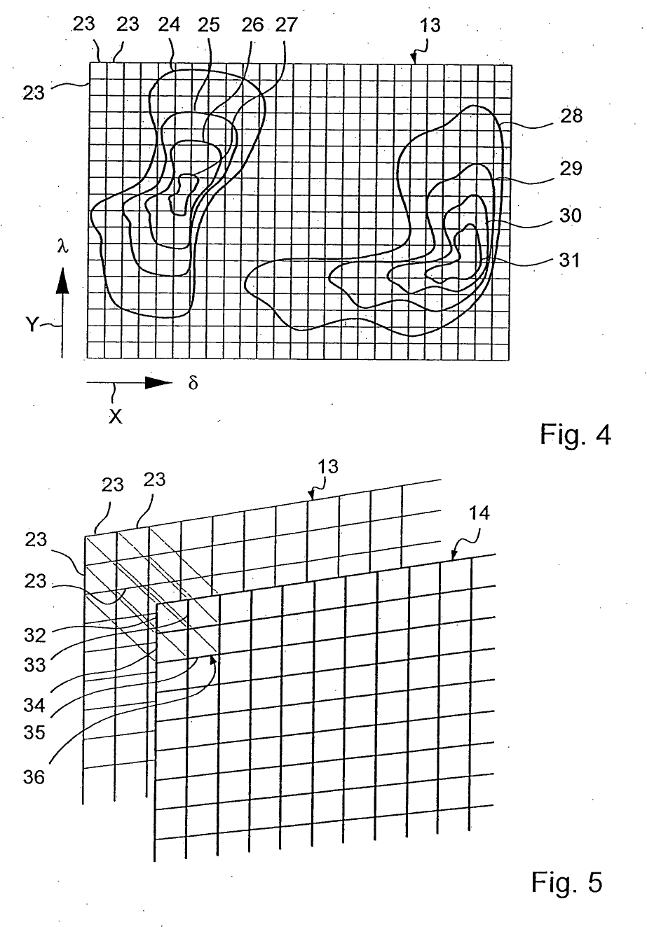

FIG. 4 shows a view of the detector of the measuring arm, and

FIG. 5 shows an exploded view of a detail of the detector and micropolarization filter arrangement.

FIG. 1 schematically shows the construction of a measurement arrangement according to the invention for combined angle-resolved and spectral reflection photometry. As will be described below in connection with FIG. 5, the measurement arrangement preferably also allows an angle-resolved and spectral ellipsometry, to be carried out at the same time.

The measurement arrangement comprises an illumination arm 1 as well as a measuring arm 2. The illumination arm 1 includes a broad-band light source 3, which emits, for example, radiation in the wavelength range of from 250 to 700 nm, a collimator 4, which is arranged following the light source 3 and produces a parallel beam 5 impinging on illuminating optics 6. If desired, a polarizer 7 may be inserted between the collimator 4 and the illuminating optics 6 (as indicated by the double arrow A), so that, in this case, polarized light is incident on the illuminating optics 6.

The illuminating optics 6 produce a converging beam 8 which is used to illuminate a specimen 9 to be examined. The angle of aperture θ of the beam 8 in the plane of incidence (in this case, the drawing plane) is about 40°, whereas the angle of aperture of the beam 8 in a plane perpendicular to the plane of incidence is preferably smaller (for example, 10° to 25°), but, of course, it may also have the same value as the angle of aperture θ. The illumination arm 1 is tilted through about 50° (angle α) relative to the normal N of the specimen, so that the beam 8 in the plane of incidence covers an incidence angle range of from 10° to 60°. As is evident from FIG. 1, both arms 1, 2 are arranged symmetrically relative to the normal N of the specimen.

The converging beam 8, which impinges on the specimen 9, interacts with the latter (being diffracted by a periodic structure, for example) to produce a diverging beam coming from the specimen 9, from which the indicated diverging beam 10 is coupled into the measuring arm 2. In this case, the measuring arm 2 is adapted and arranged such that the diverging beam 10 corresponds to the beam which would be produced by a purely specular reflection (i.e., in this case, essentially a zeroth order diffraction). Thus, the angle of aperture φ of the beam 10 is also about 40° in the plane of incidence, so that the angles of reflection of the rays of the diverging beam 10 in the plane of incidence are 10° to 60°. The propagation direction C of the beam 10, in this case, is the propagation direction of the middle ray (which is the ray having an angle of reflection of 35°). This arrangement mainly detects diffraction effects of the zeroth order from which conclusions may then be drawn as to the parameters of the specimen to be examined, whose structure (e.g. groove grating) is usually known before.

In particular, the specimen 9 and, thus, the periodic structure to be examined in the specimen 9, may be arranged such that the grating vector of the periodic structure is not in the plane of incidence. This causes the conical diffraction in which only the zeroth order of diffraction lies in the plane of incidence. In this manner, evaluation of only the zeroth order of diffraction is easily achieved.

The diverging beam 10 is coupled into an optical device 11 of the measuring arm 2, in which optical device 11 the diverging beam 10 is, on the one hand, paralleled and is, on the other hand, spectrally dispersed perpendicular to the drawing plane such that a reflected beam 12 is produced (the exact function of the optical device 11 will be described in detail below). The beam 12 thus formed is then directed to a flat detector 13 comprising a multiplicity of detector pixels arranged in lines and columns, which detector pixels may be evaluated or read out independently of each other. In the embodiment example described herein, use is made of a CCD chip.

If desired, a micropolarization filter 14, which will be described in more detail below, may be inserted between the optical device 11 and the detector 13 (as indicated by the double arrow B).

FIGS. 2 and 3 show an embodiment of the measuring arm 2, wherein the plane of incidence in FIG. 3 is the drawing plane.

The optical device 11 comprises a stop 15 (shown only in FIG. 3), which limits the angle of aperture φ of the beam 10 coupled into the optical device 11. Then follow a concave, spherical mirror 16 and a convex, spherical mirror 17, by which mirrors the diverging beam 10 is completely paralleled such that adjacent rays of the paralleled beam 18 in the drawing plane of FIG. 3 and adjacent rays of the paralleled beam 18 in a plane perpendicular to the drawing plane extend parallel to each other. Due to said paralleling, the position of each ray in the beam 18 extending in the drawing plane of FIG. 3 is given by the angle of reflection at the specimen 9. Accordingly, the ray 19 having the smallest angle of reflection δ1(=10°) is at extreme left in the paralleled beam 18, while the ray 20 having the largest angle of reflection δ2(=60°) extends at extreme right in the paralleled beam 18. The same applies to the position of the rays in planes which are parallel to the drawing plane.

Thus, both mirrors 16, 17 cause the angle of reflection δ of the rays in the diverging beam 10 be transformed into a position in the parallel beam 18. Consequently, the diverging beam is also paralleled in a first direction (in the drawing plane of FIG. 3) transversely of the propagation direction C (the direction of the middle ray).

As is evident from FIGS. 2 and 3, the paralleled beam 18 is directed onto a reflection grating 21. The reflection grating 21 is formed and arranged such that spectral dispersion is effected only perpendicular to the drawing plane of FIG. 3 (second direction). Thus, parallel ray pencils of one respective wavelength come from the grating 21 for each angle of reflection δ, the angle of reflection of the parallel ray pencils having different values as a function of the wavelength.

These parallel ray pencils impinge on a cylindrical mirror 22 and are focussed thereby on the detector 13 in the direction of spectral dispersion only.

The detector 13, which is schematically shown in FIG. 4 and comprises the multitude of individually readable photo elements (detector pixels) 23 arranged in lines and columns, is arranged in the measuring arm 2 such that spectral dispersion is effected in the column direction (arrow Y) and the transformation of the angles of reflection δ of the diverging beam 10 is effected in the line direction (arrow X). Thus, the optical device 11 causes imaging of the specimen to infinity (the detector plane is not conjugated to the specimen plane), with spectral dispersion being present in the detector plane. In this manner, the detector 13 detects an optical signature of the examined specimen portion, with angle resolution occurring in the line direction (X) and wavelength resolution occurring in the column direction (Y). Therefore, using the measuring arm 2 according to the invention, an intensity measurement may be effected, at the same time, as a function of the angle of reflection δ and as a function of the wavelength λ.

The distances of the individual optical elements 16, 17, 21, 22 and 13 of the measuring arm 2 from each other, and the radiuses of the mirrors 16, 17, 22 are indicated in the following Table 1, wherein the drawing plane of FIG. 3 corresponds to the meridian plane and the sagittal plane is perpendicular to the meridian plane.

TABLE 1

| Optical | Distance | | |
|---|---|---|---|
| elements | (mm) | Optical element | Radius (mm) |
| 9-16 | 68.13 | 16 | 54.60 (spherical, concave) |
| 16-17 | 27.00 | 17 | 34.70 (spherical, concave) |
| 17-21 | 70.00 | 22 | 103.03 (sagittal radius, concave) |
| 21-22 | 50.00 | | |
| 22-13 | 50.00 | | |

The elements of the measuring arm are arranged relative to each other in such a manner that the following angles of deflection (difference between incident ray and reflected ray) are obtained in accordance with the guiding ray principle. According to the guiding ray principle, the apex ray coming from an element nt ( or the middle ray of the beam coming from the element) serves as the input reference ray for the next structural element.

TABLE 2

| Optical | Angle of | |
|---|---|---|
| element | deflection (°) | |
| 16 | 57.43 | Deflection in the meridian direction only |
| 17 | 110.00 | Deflection in the meridian direction only |
| 22 | 20 | Deflection in the sagittal direction only |

The grating 23 is a plane line rating having a grating frequency of 500 lines/mm (in which case, one line is a complete structural period), and is arranged such that the angle of incidence at the grating relative to the normal of the grating is 11.824°. The angle of deflection (in the sagittal direction) for a ray having a wavelength of 380.91 nm is 12.652°. The angle of deflection of 20° at the cylindrical mirror 22 indicated in Table 2 also relates to the wavelength of 380.91 nm. The ray of this wavelength reflected by the cylindrical mirror 22 impinges vertically on the detector 13.

Since, in the measuring arm 3, paralleling is first effected by means of both mirrors 16 and 17 and, thus, without the use of refractive elements, said paralleling advantageously does not produce any chromatic aberration.

In a manner identical with the measuring arm 2, the illuminating optics 6 of the illumination arm 1 may comprise two spherical mirrors (not shown) as well as a stop (not shown), so as to produce the desired converging beam 8 upon impingement of a parallel beam 5.

In the measurement of periodic structures, the beam diameter of the incident beam 8 on the specimen 9 is preferably selected such that it illuminates at least a few periods of the structure. In the manufacture of semiconductors, the period of such structures (such as, e.g., lines distanced from each other, which should have a predetermined width and height as well as a predetermined flank angle, if the process is carried out correctly) may be 150 nm, so that a beam diameter of several 10 μm is then aimed for. Depending on the geometry of the specimen (which changes due to process fluctuations, for example), the measured optical signature also changes, so that conclusions may be drawn, by known methods (e.g. neuronal networks), as to the actual values of the desired parameters (such as line width, line height, flank angle), on the basis of the measured optical signature.

Said measurements have shown that the sensitivity (i.e. the changes of the optical signature as a function of a change of the parameter to be examined, such as the width and height of the parallel lines) is not constant over the entire beam diameter of the beam impinging on the detector 13, but depends very much on the particular type of specimen (e.g. photoresist on silicon, etched silicon, etched aluminum) and on the particular geometries (e.g. one-or two-dimensional repetitive structures).

FIG. 4 shows the individual pixel elements 23 of the detector 13 as squares, with the sensitivity being indicated as a function of the wavelength λ and of the angle of reflection δ for a first type of specimen by contour lines 24, 25, 26, 27 and for a second type of specimen by contour lines 28, 29, 30, 31. The contour lines may be experimentally and/or theoretically determined.

When measuring the first type of specimen, the detector 13 is preferably controlled such that only those pixel elements 23 lying within contour line 24 are read, while, when measuring the second type of specimen, only those pixel elements 23 lying within the contour line 28 are read. This allows only the relevant pixel elements 23 to be detected and evaluated, so that said evaluation is not unnecessarily slowed down by the less relevant information of the remaining image pixel elements.

As the detector 13, use is preferably made of detectors in which individual image pixels may be selectively read. Examples of these include a CMOS image detector or also a CID image detector (charge injection device image detector).

In a further embodiment of the described embodiment, the polarizer 7 is arranged in the illumination arm 1 such that the beam coupled into the illuminating optics 6 is linearly polarized and, thus, has a defined or known polarization condition. The micropolarization filter 14, which is preferably arranged immediately preceding the detector 13, is inserted between the optical device 11 and the detector 13 in the measuring arm 2.

The micropolarization filter 14 comprises a multiplicity of filter pixels 32, 33, 34, 35 arranged in lines and columns, each of said filter pixels 32, 33, 34, 35 being associated with exactly one detector pixel 23, as is evident from the schematic exploded view of a portion of the detector 13 and of the micropolarization filter 14 in FIG. 5. In this case, 2 times 2 filter pixels respectively form a group of pixels 36, with three filter pixels 32, 33, 34 (e.g. fine metal gratings, which can be produced using known microstructuring techniques) of the group of pixels 36 being analyzers with different passage directions or main axis directions (e.g. 0°, 45°, 90°) for polarized radiation and the fourth filter pixel 35 being transparent. Thus, the detector pixels 23 associated with the three analyzer pixels 32, 33, 34 allow the polarization condition to be detected, and the fourth detector pixel 23, which is associated with the transparent filter pixel 35, enables an intensity measurement. Accordingly, the resolution in this embodiment is reduced by the factor 2 as compared with the previously described embodiment, but additional information concerning the changes of the polarization condition is obtained, thus also allowing to simultaneously effect spectral and angle-resolved ellipsometry by one single measurement.

If a space-resolved measurement is to be effected using the described measurement arrangement, the distance of the specimen 9 to both arms 2 and 3 is preferably adjusted such that the converging beam 8 has as small as possible a diameter on the specimen 9. The converging beam 8 is, thus, focussed on the specimen in the best possible manner. Further, the specimen 9 is moved relative to both arms 2 and 3, so that the measurement described in connection with the above embodiments may be effected for each point. The space resolution is thus achieved by measuring separate points, since the individual measurements per se do not provide space-resolved information. This is due to the fact that the measuring arm of the measurement arrangement according to the invention does not detect an image of the examined site on the specimen, but an integral optical signature (the optical signature averaged via the specimen spot).

Movement of the specimen 9 relative to the arms 2 and 3 is preferably effected by means of a specimen table (not shown) on which the specimen 9 is held, said specimen table also allowing the distance to the arms 2, 3 and, thus, the beam diameter of the beam 8 on the specimen 9 to be adjusted. Alternatively, of course, both arms 2 and 3 may also be moved relative to the specimen 9, or it is also possible to combine both movements.

1. A measurement arrangement comprising an optical device, into which a diverging beam coming from a specimen is coupled for measurement, and further comprising a detector, which is arranged following said optical device and comprises a multiplicity of detector pixels arranged in one plane and evaluable independently of each other, wherein the optical device spectrally disperses the diverging beam in a first direction transversely of the propagation direction of the beam and directs it onto the detector, wherein the optical device also parallels the beam, before the latter impinges on the detector, in a second direction transversely of the propagation direction such that rays of the beam impinging on the detector, which are adjacent to each other in the second direction, extend parallel to each other.

2. The measurement arrangement as claimed in claim 1, wherein the optical device effects said spectral dispersion such that, in the first direction, focussing occurs in the plane of the detector pixels.

3. The measurement arrangement as claimed in claim 2, wherein the optical device comprises a cylindrical mirror for focusing.

4. The measurement arrangement as claimed in claim 1, wherein the optical device comprises a dispersive element, in particular a groove grating, for spectral dispersion.

5. The measurement arrangement as claimed in claim 4, wherein the dispersive element is a reflective element.

6. The measurement arrangement as claimed in claim 1, wherein the optical device comprises a mirror, in particular a spherical mirror, for paralleling.

7. The measurement arrangement as claimed in claim 1, wherein the optical device comprises a first optical module for paralleling the coupled-in beam and a second optical module arranged following the first optical module, for spectral dispersion of the paralleled beam.

8. The measurement arrangement as claimed in claim 7, wherein the first optical module only comprises mirror elements for paralleling.

9. The measurement arrangement as claimed in claim 1, wherein the detector pixels are arranged in lines and columns and spectral dispersion is effected in a line direction or in a column direction.

10. The measurement arrangement as claimed in claim 1, wherein a micropolarization filter is arranged preceding the detector, said micropolarization filter comprising a multitude of groups of pixels, each of which comprise at least two analyzer pixels for ellipsometry, having differently oriented main axes, and a transparent pixel for photometry.

11. The measurement arrangement as claimed in claim 1, wherein an illumination arm is provided which can direct a beam onto the specimen to be examined in such a manner that the diverging beam is produced.

12. A method of measurement comprising the steps of:
directing a beam onto a specimen to be examined, such that a diverging beam comes from the specimen,
effecting spectral dispersion of the diverging beam in a first direction transversely of the propagation direction of the diverging beam, and
directing the spectrally dispersed beam onto a detector which comprises a multitude of detector pixels arranged in one plane and evaluable independently of each other, wherein the diverging beam, before impinging on the detector, is also paralleled in a second direction transversely of the propagation direction such that the rays of the beam impinging on the detector, which are adjacent to each other in the second direction, extend parallel to each other.

13. The method of measurement as claimed in claim 12, wherein only some predetermined detector pixels are evaluated, depending on the specimen to be examined.

14. The method of measurement as claimed in claim 12, wherein the beam, which is directed onto the specimen, has a defined polarization condition and that part of the beam directed onto the detector is guided through analyzers.

15. The method of measurement as claimed in claim 12, wherein the beam is focussed on the specimen.
